(19) United States
(12) Patent Application Publication
(10) Pub. No.: US 2025/0188833 A1
(43) Pub. Date: Jun. 12, 2025

(54) GAMMA RAY GUIDED RESISTIVITY ANISOTROPY INVERSION OF MULTI-COMPONENT INDUCTION

(71) Applicant: Halliburton Energy Services, Inc., Houston, TX (US)

(72) Inventors: Ahmed Elsayed FOUDA, Pearland, TX (US); Junsheng HOU, Houston, TX (US); Rojelio MEDINA, Katy, TX (US); Christopher Michael JONES, Houston, TX (US)

(73) Assignee: Halliburton Energy Services, Inc., Houston, TX (US)

(21) Appl. No.: 18/536,712

(22) Filed: Dec. 12, 2023

Related U.S. Application Data
(60) Provisional application No. 63/534,703, filed on Aug. 25, 2023.

(51) Int. Cl. E21B 47/135; E21B 47/002; G01V 3/28; G01V 3/38

(52) U.S. Cl. CPC E21B 47/135; E21B 47/0025; G01V 3/28; G01V 3/38

(57) ABSTRACT

Described herein are systems and techniques for improving the accuracy of computer models that determine properties of subterranean rock formations. Such systems and methods may perform multiple sets of calculations using data collected by different types of sensing devices that may be deployed in a wellbore. For example, a first set of inversions may be made on data collected by an electromagnetic (EM) sensing device and a second set of inversions may be made using EM data and data collected by a gamma ray (GR) sensing device. Such methods may be useful when making determinations regarding subterranean features that include laminated structures. For example, when rock structures include layers of sand and layers of shale.

### CROSS-REFERENCE TO RELATED APPLICATIONS

This application claims priority to U.S. Provisional Patent Application No. 63/534,703, filed Aug. 25, 2023, entitled “GAMMA RAY GUIDED REAL-TIME RESISTIVITY ANISOTROPY INVERSION OF MULTI-COMPONENT INDUCTION,” the contents of which are incorporated herein by reference in their entirety.

### TECHNICAL FIELD

The present disclosure is generally directed to improving determinations made by computer models. More specifically, the present disclosure is directed to increasing the accuracy of resistivity values and/or other factors based on performing evaluations on data collected by different types of sensing devices.

### BACKGROUND

When managing oil and gas drilling and production environments (e.g., wellbores, etc.) and performing operations in the oil and gas drilling and production environments, it is important to obtain measurements and other sensor data and details regarding Earth formations and conditions in the vicinity of a wellbore. Such data may be used to understand downhole conditions and help manage the wellbore and associated operations. For example, sensor data can be used to identify features within the Earth formations and whether the Earth formations are stable and are being used in a controlled way. However, the downhole conditions and constraints can create significant challenges in deploying systems such as sensors and monitoring conditions downhole. Furthermore, certain types of Earth formations may increase errors or uncertainty of determinations made by a computer model.

Non-limiting illustrative examples of such conditions and constraints can include extreme temperatures, extreme pressures, space constraints, and complex mixtures of different elements, among others.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a form of an electromagnetic (EM) sensing device that may include multiple sensing elements, in accordance with various aspects of the subject technology.

FIG. 3 illustrates results of simulations made using the laminated sand-shale equations above.

FIG. 4 illustrates actions that may be performed with a two-mode (dual-mode) inversion workflow, in accordance with various aspects of the subject technology.

FIG. 5 illustrates raw coaxial component data of a set of electromagnetic (EM) data associated with a set of sensing elements, in accordance with various aspects of the subject technology.

FIG. 6 illustrates data associated with measurements made by an MCI device, in accordance with various aspects of the subject technology.

FIG. 7 illustrates inverted The MCI inverted resistivity values and anisotropy ratio values of the inversion without an enhancement for depth, in accordance with various aspects of the subject technology.

FIG. 8 illustrates a plot of EM log data that has been inverted and shows a plot of gamma ray log data, in accordance with various aspects of the subject technology.

FIG. 9 illustrates an example computing device architecture which can be employed to perform various steps, methods, and techniques disclosed herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure. Various types of sensors or sensing devices may be deployed in a wellbore when data is collected.

Described herein are systems, apparatuses, processes (also referred to as methods), and computer-readable media (collectively referred to as “systems and techniques”) for improving the accuracy of computer models that determine properties of subterranean rock formations. Such systems and methods may perform multiple sets of calculations using data collected by different types of sensing devices that may be deployed in a wellbore. For example, a first set of inversions may be made on data collected by an electromagnetic (EM) sensing device and a second set of inversions may be made using EM data and data collected by a gamma ray (GR) sensing device. Such methods may be useful when making determinations regarding subterranean features that include laminated structures. For example, when rock structures include layers of sand and layers of shale.

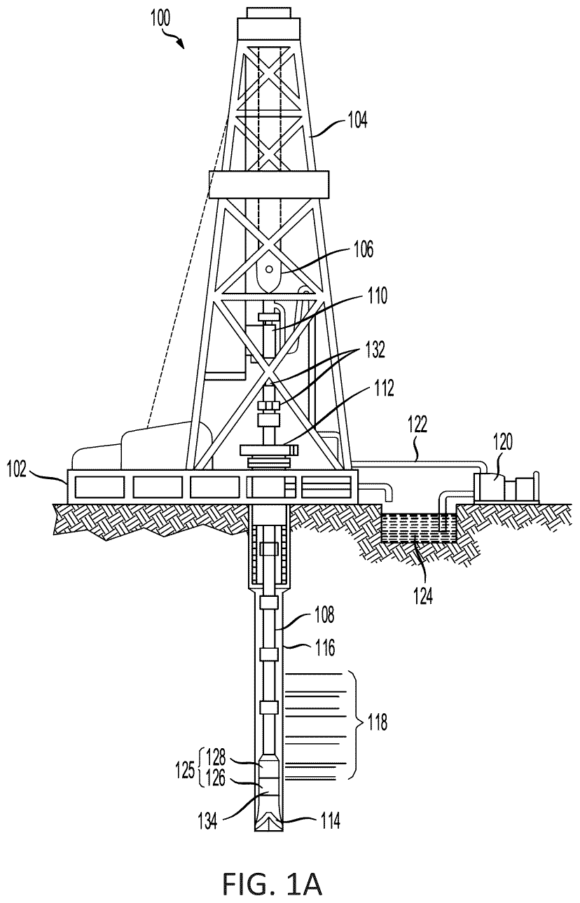

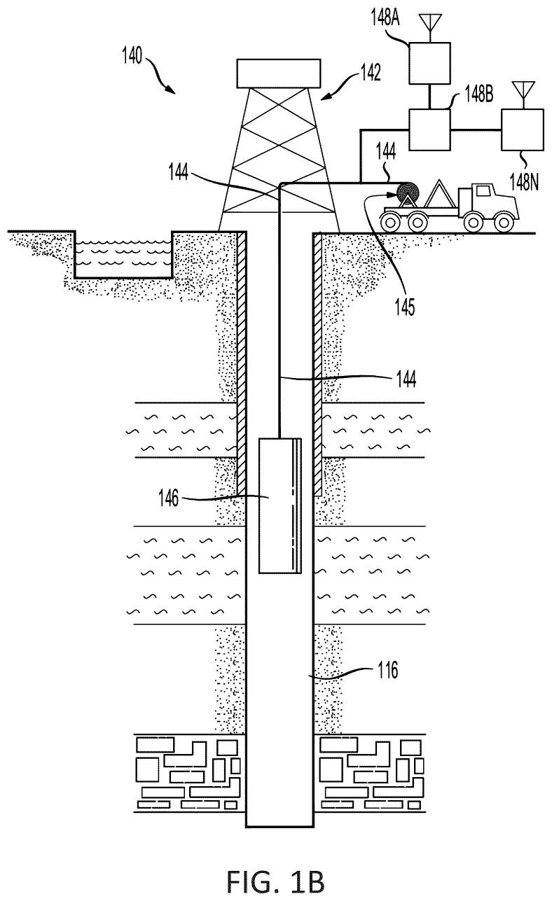

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

A tool deployed in a wellbore may include one more types of sensors or sensing devices. In some instances, a device that senses electromagnetic (EM) energy (e.g., an EM sensing device) may be used to collect data used to identify resistivities or changes in resistance of structures in a wellbore. Another device that may be used to collect data in a wellbore is a gamma ray (GR) sensing device.

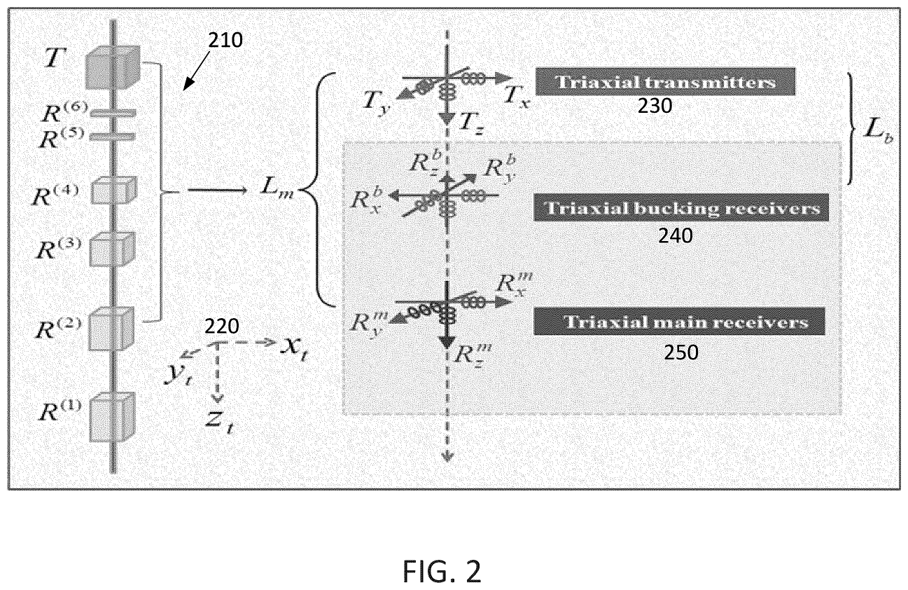

FIG. 2 illustrates a form of an electromagnetic (EM) sensing device that may include multiple sensing elements. Such an EM sensing device may be referred to as a multi-component induction (MCI) tool. The MCI tool 210 illustrates on the left side of FIG. 2 includes a transmitting element T and multiple receiving elements (R⁽¹⁾, R⁽²⁾, R⁽³⁾, R⁽⁴⁾, R⁽⁵⁾, and R⁽⁶⁾). This transmitting element T and receiving elements R⁽¹⁾, R⁽²⁾, R⁽³⁾, R⁽⁴⁾, R⁽⁵⁾, and R⁽⁶⁾ may each include three coils oriented three perpendicular axes 220 (along the Xt axis, the Yt axis, and the Zt axis). As such, each of these transmitting and receiving elements may be referred to as triaxial coils used to transmit or receive electromagnetic signals.

The MCI tool 210 may include a set of triaxial transmitters 230 that include coils Tx, Ty, and Tz. This MCI tool 210 may also include one or more sets of triaxial bucking coils R^{b}x, R^{b}y, and R^{b}z, and may include one or more sets of triaxial main coils R^{m}x, R^{m}y, and R^{m}z. A distance Lm in FIG. 2 may be a measure of distance between triaxial transmission coils 230 and main receiving coils 250, and a distance Lb in FIG. 2 may be a measure of distance between triaxial transmission coils 230 and triaxial bucking coils 240.

In operation transmission coils 230 may transmit pulses of EM energy that are received by triaxial bucking coils 240 and triaxial main coils 250. EM energy received by a set of receiving coils may induce voltages into each respective coil of the set of received coils. This may be expressed as 3×3 tensor equation 1 shown below. Such a 3×3 tensor may describe a multilinear relationship between sets of algebraic objects (in this instance, voltages) related to a vector space. Here Vᵢⱼ is a measured-voltage coupling, where the first subscript i indicates the transmitter direction, and the second subscript j indicates the receiver direction. The voltages measured in the receiver coils, expressed in equation 1, may be calibrated into apparent conductivities to obtain the following apparent-conductivity tensor expression of equation 2, where: σ̅ₐ̅ is referred to as the MCI apparent conductivity tensor in a tool or measurement coordinate system (xₜ, yₜ, xₜ) that has nine couplings σᵢⱼ. In practical applications, the notation of equation 3 may be used to represent the MCI apparent conductivity tensor (equation 2) in a simplified form:

$${V}^{\overline{\_}} = {( {V}_{ij} )}_{( 3 \times 3 )} = ( \begin{matrix}{V}_{xx} & {V}_{xy} & {V}_{xz} \\ {V}_{yx} & {V}_{yy} & {V}_{yz} \\ {V}_{zx} & {V}_{zy} & {V}_{zz}\end{matrix} ) , i , j = x , y , z \qquad Equation 1$$

$${{σ}_{a}}^{\overline{\_}} = {( {σ}_{ij} )}_{( 3 \times 3 )} = ( \begin{matrix}{σ}_{xx} & {σ}_{xy} & {σ}_{xz} \\ {σ}_{yx} & {σ}_{yy} & {σ}_{yz} \\ {σ}_{zx} & {σ}_{zy} & {σ}_{zz}\end{matrix} ) , i , j = x , y , z \qquad Equation 2$$

$${{σ}_{a}}^{\overline{\_}} = ( \begin{matrix}XX & XY & XZ \\ YX & YY & YZ \\ ZX & ZY & ZZ\end{matrix} ) \qquad Equation 3$$

Once we have data from MCI logging tool 210 for multiple subs (receiving elements) at multiple frequencies, the resistivity anisotropy, formation “dip,” and compensated resistivity (e.g., array compensated resistivity tool—ACRT) logs may be obtained by a data inversion process that processes data sensed by MCI tool 210. This resistivity anisotropy may be a structural property of non-uniform measures of resistivity in different directions. Formation dip may be an angle between a horizontal plane and a surface of a wellbore or subterranean formation.

Relying on inversion of resistivity data to identify parameters of subterranean rock formations can, however, incorrectly estimate values of vertical resistivity (Rv), horizontal resistivity (Rh), and/or anisotropy ratio Rv/Rh (i.e., Rvh). For example, in instances where rock formations are thinly laminated, there may be effects associated with a sensing antenna array (e.g., horn effects) or effects associated with boundaries (e.g., bed boundaries) that cause values of Rv or Rvh.

To address potential Rv or Rvh overestimation issues, techniques of the present disclosure may be directed to using combinations of inversion of resistivity data and inversions of data collected by a gamma ray (GR) device (GR data). Such techniques may be referred to as GR-guided resistivity anisotropy inversion of MCI logging measurements. This technique may improve the accuracy of determination made in certain type of formations (e.g., in laminated formations). An example of a laminated formation may include alternating layer of sand and shale. This enhanced inversion includes may include a two-pass inversion, where in a first pass, the inversion, may not GR-guided. In this first invertion, it may be assumed that values of Rh and Rvh may be associated with thick shale sections. Next, GR-derived parameters or values of Rvh and Rv may be identified from a set of GR log data. A set of GR log data may have been collected by a GR device that is or was deployed in a wellbore. Values of Rvh or Rv derived from GR log data may be referred to as pseudo Rvh and pseudo Rv values or parameters and these pseudo values/parameters may be respectively represented as PRvh and PRv. Values of RRvh and PRv may be identified by an inversion process that uses a set of GR log data along the thick shale sections.

Values of PRvh or PRv data may be used with a second inversion is performed, these values may be used as a regularization term for Rvh, as an upper bound for Rv or Rvh, and/or as an initial estimate of Rvh or Rv. Once the PRvh or PRv are computed, a second pass inversion may be performed to identify values of Rh, Rv, and dip. Such a process may be referred to as a two-pass inversion workflow, where a first inversion may be performed using EM data and a second inversion may be performed using combinations of EM data and GR data.

In certain instances, resistivity anisotropy, horizontal resistivity, and formation dip may be obtained based on the inversion of MCI logging data. In an MCI inversion, a bound constrained nonlinear least-squares problem may be solved. A formula used to regularize bound constrained optimizations may use equation 4 below

$$Bound Constrained Optimization Formula \qquad Equation 4$$

$$min O ( \overline{X} ) = min \frac{1}{2} \{ ϕ ( \overline{X} ) + λ \cdot {φ}_{reg} ( \overline{X} ) \}$$

$$Subject to ( s . t . ) {\overline{X}}_{min} \leq \overline{X} \leq {\overline{X}}_{max}$$

In the above equation 4, O(X̅) is the objective (or cost) function of the inversion, which may be defined as the summation of the weighted residual square term ϕ(X̅) and a regularization term

$${φ}_{reg} ( \overline{X} ) , O ( \overline{X} ) = \frac{1}{2} \{ ϕ ( \overline{X} ) + λ \cdot {φ}_{reg} ( \overline{X} ) \} ;$$

where λ is the “regularization factor” or is called a “non-negative damping factor;” X̅ is an inverted model vector, and X̅ₘᵢₙ and X̅ₘₐₓ are the lower and upper bounds of X̅, respectively. A weighted residual square term ϕ(X̅) may given as ϕ(X̅)=∥W̅_{d}·ē(X̅)∥².

Here, W̅_{d} may be a “data weight matrix,” ē(X̅) is a residual vector, ē(X̅)=Y_{obs}−Yₚᵣₑ(X̅), Y_{obs} and Yₚᵣₑ(X̅) are an observed data vector and a simulated/predicted vector may be based a model assumption (e.g., R1D model, zero-D and V1D models). The regularization term φ_{reg}(X̅) may be a single term or the sum of multiple regularization sub-terms. For example, when there is only one regularization sub-term, φ_{reg}(X̅)=∥W̅ₓ·(X̅−X̅ₚ)∥²; where, W̅ₓ is the model weight matrix, and X̅ₚ is a prescribed model vector.

An initial estimation or guess of vector X̅ᵢₙᵢ of X̅ may be made to initiate an inversion iteration. In instances when a gradient-based iteration algorithm is used to solve the above inverse problem, it may be consistent with an algorithm such as the regularized Gauss-Newton algorithm. For the inversion problem of identifying formation dip, horizontal resistivity Rh, and vertical resistivity Rv (or resistivity anisotropy ratio Rvh=Rv/Rh), a bound constraint X̅ₘᵢₙ≤X̅≤X̅ₘₐₓ may be further written as in terms of vector elements. In some instances, dip values maybe constrained based on a lower bound and an upper bound. In such an instance values of dip will be constrained to be between the lower dip bound and the higher dip bound (dipMin≤dip≤dipMax). Here, dipMin and dipMax may be respectively a lower threshold and upper threshold of values that may be assigned with a formation dip.

Values of Rh and/or Rv may be bound or constrained. As such, values of Rh may be constrained to be between a minimum boundary and a maximum boundary (RhMin≤Rh≤RhMax) and values of Rv may be constrained to be between a minimum boundary and a maximum boundary RvMin≤Rv≤RvMax.

An iterative inversion process may be dependent on the selection of a regularization term, lower boundary and upper boundary constraints, and an initial guess or estimate. The MCI inversion may show overestimated resistivity anisotropy ratio Rvh (or vertical resistivity Rv) that could be caused by a weak regularization term. Furthermore, boundary constraints plus the horn effects on MCI measurements in areas around boundaries (e.g., coplanar MCI measured data based on deployment of an EM tool that includes multiple sensing couplings XX and YY).

In an instance when a shale resistivity assumed to be (microscopically) anisotropic and sand resistivity is isotropic in laminated sand-shale formations, the following equations may be applied when evaluations of shale and sand resistivity plus shale volume are performed. Such evaluations may be based on a volumetric rock-physics model.

$$\frac{1}{{R}_{h}} = \frac{{V}_{shale}}{{R}_{shale}^{h}} + \frac{1 - {V}_{shale}}{{R}_{sand}} ,$$

$$or {C}_{h} = {C}_{shale}^{h} \cdot {V}_{shale} + ( 1 - {V}_{shale} ) \cdot {C}_{sand} ;$$

$${R}_{v} = {V}_{shale} \cdot {R}_{shale}^{v} + ( 1 - {V}_{shale} ) \cdot {R}_{sand} .$$

$$Laminated Sand - Shale Equations$$

Here, values of Rₕ (or horizontal conductivity

$${C}_{h} = \frac{1}{{R}_{h}} )$$

and Rᵥ may be derived based on inversion of MCI logging data. In the laminated shale equations above, Rₛₕₐₗₑ^{h} (or horizontal conductivity=Cₛₕₐₗₑ^{h}=1/Rₛₕₐₗₑ^{h}) and Rₛₕₐₗₑ^{v} are the horizontal and vertical resistivity of the shale formation; R_{sand} may be a measure of clean sand resistivity (or conductivity C_{sand}=1/R_{sand}), and Vₛₕₐₗₑ is the volumetric fraction of the laminated shale. If we ignore the dispersed shale, Vₛₕₐₗₑ is the total shale volume. Otherwise, we perform some correction to the total shale volume from nuclear logs.

Here, Rₛₕₐₗₑ^{h} and Rₛₕₐₗₑ^{v} are generally selected from Rₕ and Rᵥ logs in the neighboring shale, and then we solve R_{sand} and Vₛₕₐₗₑ with the above laminated shale equations.

If Rₛₕₐₗₑ^{h}, Rₛₕₐₗₑ^{v}, and R_{sand} are given, the resistivity anisotropy ratio

$${R}_{vh} = \frac{{R}_{v}}{{R}_{h}}$$

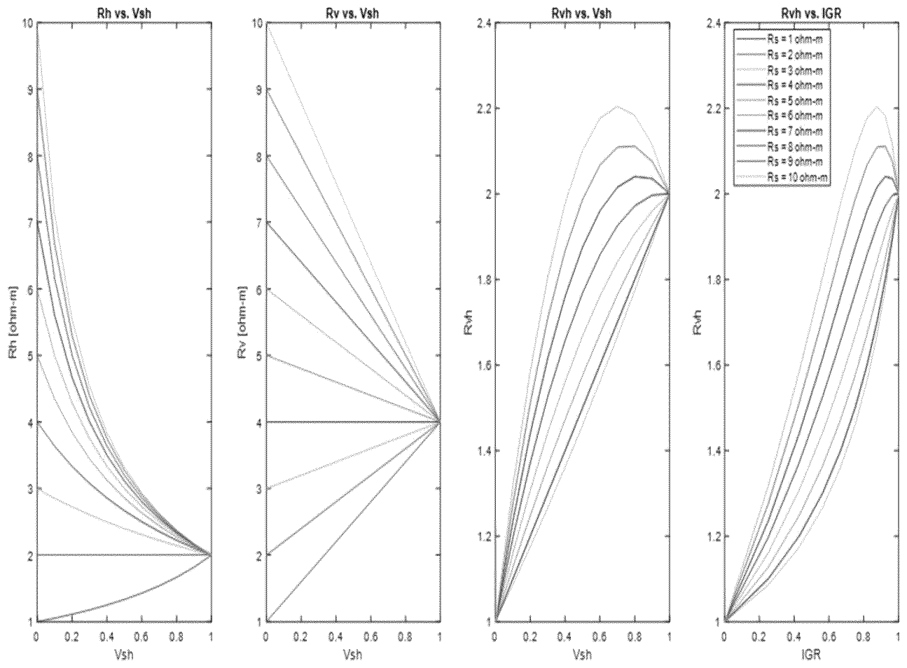

is a function of the single variable Vₛₕₐₗₑ. Because of this, we can derived a Rᵥₕ log from the Vₛₕₐₗₑ or Gamma (GR) log when Vₛₕₐₗₑ is linearly or nonlinearly scaled from GR. This may be based on a GR-derived or pseudo Rᵥₕ, denoted as PRvh. Once PRvh and Rh are known, the so-called GR-derived or pseudo Rv, denoted as PRv may be obtained. For example, let us define the GR index as follows: IGR=(GR−GRmin)/(GRmax−GRmin). Here, IGR is the GR index, it can be related to Vsh with one of various empirical models. In instances when the Stieber model is used, IGR may be identified according to the formula where IGR=3*Vsh./(1+2*Vsh). By performing calculations of a volumetric rock-physics model, we can also identify Rvh by the equation R_{Vh}=Rᵥ*Cₕ. In the above laminated shale equations, let us assume Rₛₕₐₗₑ^{h}=2 and Rₛₕₐₗₑ^{v}=4. Based on this we can study the relations of Rh vs Vsh; Rv vs Vsh; Rvh vs Vsh; and Rvh vs IGR, and the simulated results are shown in FIG. 3.

FIG. 3 illustrates results of simulations made using the laminated sand-shale equations above. By reviewing FIG. 3, the following observations may be made:
Rh and Rv relationships with Vₛₕₐₗₑ (Vsh) are highly dependent on R_{sand} (or Rs).
Rvh exhibits a near-linear monotonic behavior with Vsh for low Vsh. For higher Vsh and higher Rs, non-monotonic behavior is observed. Rvh relationship with Vsh is less dependent on Rs compared with Rv or Rh.
Rvh exhibits a near-linear monotonic behavior with IGR on a wider range of Vsh.
Rvh relationship with Vsh or IGR may be approximated by linear models that are independent of Rs. The approximation error increases with higher Vsh and Rs.

As discussed above, let us assume that PRvh is linearly correlated with the GR or the shale volume in laminated formations, then we can use linear equations for estimating PRvh and PRv: PRvh=f(GR)=b*GR+c; Or PRvh=f(Vₛₕₐₗₑ)=B*Vₛₕₐₗₑ+C; and PRv=Rh*PRvh. Here

$$b = \frac{Rvh max - Rvh min}{GR max - GR min} ,$$

c=Rvhmin−b*GRmin; B=b*(GRmax−GRmin), and C=b*GRmin+c; GRmin and GRmin are the min and max values of the GR log readings; Rvhmin and Rvhmin are the min and max values of the Rvh along the log profile. Obviously, the above equations provide an estimation of both Rvh and Rv.

According to the volumetric rock-physics model and linear correlation between PRvh and GR or the shale volume, we have the following observations:
When Vₛₕₐₗₑ=1 (e.g., in a shale section) Rₕ=Rₛₕₐₗₑ^{h}; Rᵥ=Rₛₕₐₗₑ^{v};

$${R}_{vh} = \frac{{R}_{shale}^{v}}{{R}_{shale}^{h}} = {R}_{shale}^{vh} = max {PR}_{shale}^{vh} ;$$

When Vₛₕₐₗₑ=0 (e.g., in a clean sand section), Rₕ=Rᵥ=R_{sand}; Rᵥₕ=1=min PRₛₕₐₗₑ^{vh}

Based on this, Rᵥₕ should be in the range of 1 and max PRₛₕₐₗₑ^{vh}, namely 1≤Rᵥₕ≤max PRₛₕₐₗₑ^{vh}. Here, max PRₛₕₐₗₑ^{vh} is the max resistivity anisotropic ratio of the shale formation. From the above discussions, it is easily observed that we can use the PRvh or PRv for the following applications in the MCI inversion. 1. New regularization term is added into the cost function of the inversion; 2. max PRₛₕₐₗₑ^{vh} and max PRₛₕₐₗₑ^{vh}Rh can be used as upper bounds of Rvh or Rv; and 3. PRvh can be used as an initial guess of Rvh or Rv.

From the GR-derived PRvh (or PRv) as discussed above an enhanced MCI inversion process may be expressed using the enhanced inversion equations below:

$$min O ( \overline{X} ) = min \frac{1}{2} \{ ϕ ( \overline{X} ) + λ \cdot {φ}_{reg} ( \overline{X} ) \}$$

$$Subject to : dip Min \leq dip \leq dip Max ; \\ Rh Min \leq Rh \leq Rh Max ; 1 \leq Rvh \leq max PRvh$$

$$Enhanced Inversion Equations$$

Here, maxPRvh may be estimated from the PRvh log. The regularization term φ_{reg}(X̅) of the objective function is defined as the sum of two regularization sub-terms, namely: φ_{reg}(X̅)=∥W̅ₓ·(X̅−X̅ₚ)∥²+(Rv−PRvh*Rh)². When the Rvh is inverted, then we have an expression of φ_{reg}(X̅) as φ_{reg}(X̅)=∥W̅ₓ·(X̅−X̅ₚ)∥²+(Rvh−PRvh)². This enhanced MCI inversion includes the GR-derived PRvh (or PRv).

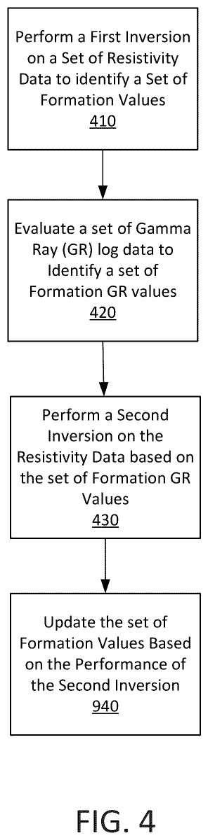

FIG. 4 illustrates actions that may be performed with a two-mode (dual-mode) inversion workflow is performed. At block 410 a first set of mathematical operations may be performed on a set of formation resistivity data to identify a set of formation values. This first set of mathematical operations may include a first inversion that obtains values of Rh, Rv, and/or Rvh. These operations may be performed based on the assumption that Rh and/or Rv derived from these operations can be associated with at least a threshold level of quality. Resistive data used in the first set of mathematical operations may have been collected by an EM sensing device like an MCI device and the collected data may be stored in a set of resistivity data logs.

At block 420, a set of gamma ray (GR) formation log data may be evaluated. This GR formation log data may have been collected when identifying a set of formation GR values. This may include providing GR log data collected by a GR sensing device to processor executing instructions of a computer model. This may also include providing values of Rh and/or Rv identified in the first mathematical operation (e.g., a first inversion) to the computer model. The evaluations performed at block 420 may identify the pseudo Rv, pseudo Rh, and/or pseudo Rvh data discussed above and this data may be stored as a log profile. Data associated with the presence of uranium may be removed from a set of GR data before the second evaluations are performed using the GR data. In such instances, data associated with other radioactive elements (e.g., thorium, potassium, or other elements) may not be removed.

At block 430, a second set of mathematical operations may be performed on the formation resistivity data based on the set of formation GR values. This second set of mathematical operations may include a second inversion that may, at least in part be based on the pseudo Rv, pseudo Rh, and/or pseudo Rvh log data. In certain instances, block 410, 420, and 430 may be looped as part of the inversion workflow. At block 440, the set of formation values may be updated based on the performance of the second set of mathematical operations.

This new two-mode inversion workflow may consist of two inversions, where the first inversion may be run without GR log data (e.g., using only EM data). This may allow data that identifies values of Rh and max Rvh that at least meet a quality threshold. Based on log data collected by a GR device, and the values of Rh and Rvh identified by performing the first inversion, we can generate pseudo Rvh or pseudo log (e.g.: respectively PRvh and PRv) values.

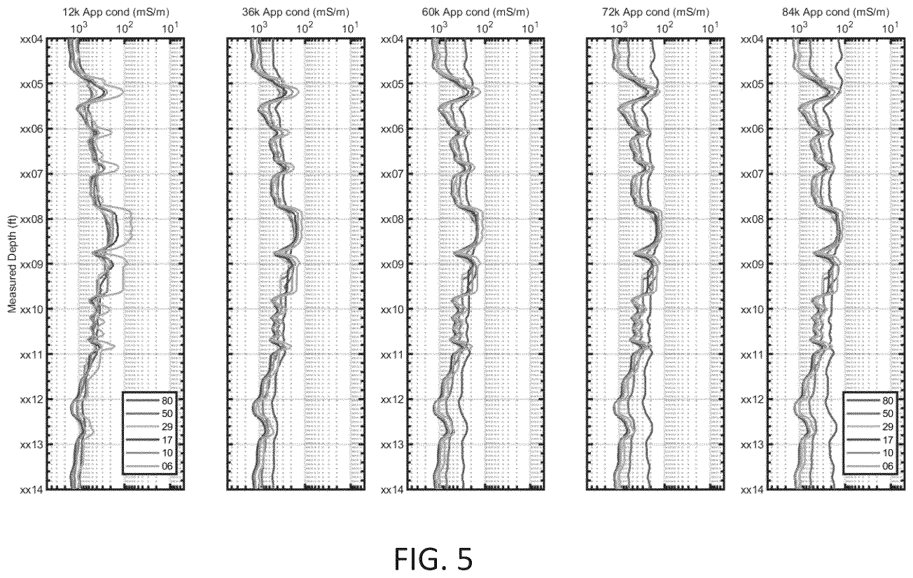

FIG. 5 illustrates raw coaxial component data of a set of electromagnetic (EM) data associated with a set of sensing elements (e.g., ZZ subs sensing elements). This set of EM data may have been collected by an MCI device and may include measurements at 5 frequencies (12 k, 36 k, 60 k, 72 k, and 84 kHz), and 6 sub-arrays (80, 50, 29, 17, 10, and 06 subs) for a depth section, for example.

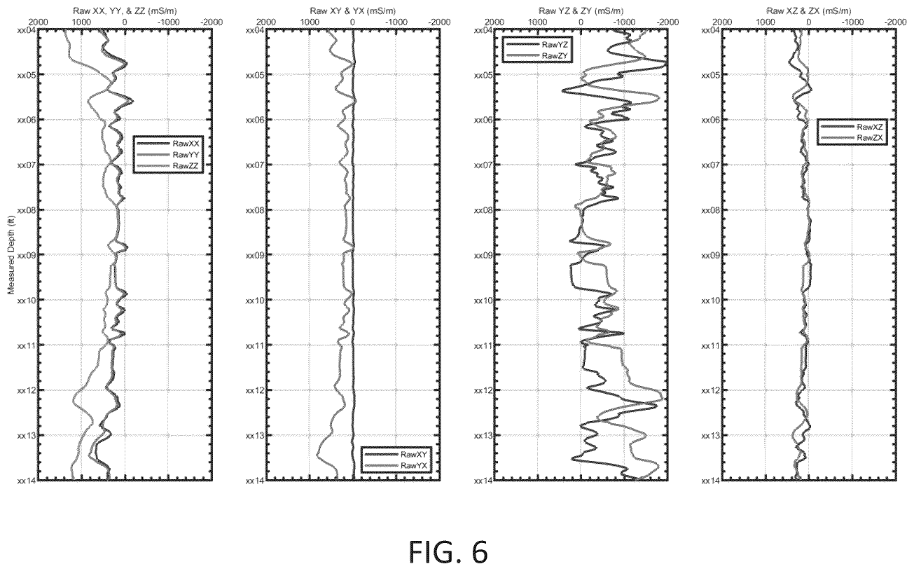

FIG. 6 illustrates data associated with measurements made by an MCI device. The data of FIG. 6 includes nine components (XX, YY, ZZ, XY, YX, YZ, ZY, and XZ and ZX) of measurements made at 36 kHz and 29 sub-array. Around depth 24850′ and depth range of 24890′-24900′, coplanar components XX and YY show the stronger horn effects around the boundaries compared to the ZZ component. For the point-by-point MCI inversion, this leads to the overestimation of Rv or Rvh if there are no appropriate regularization and upper bound constraint in inversion.

FIGS. 5-6 show the raw ZZ data for six subs and all 5 frequencies where MCI measurements for 36 k and 29 sub along a depth section. From those Figures, we observe some depth sections show strong horn effects on the XX, YY, and XY, YX logs.

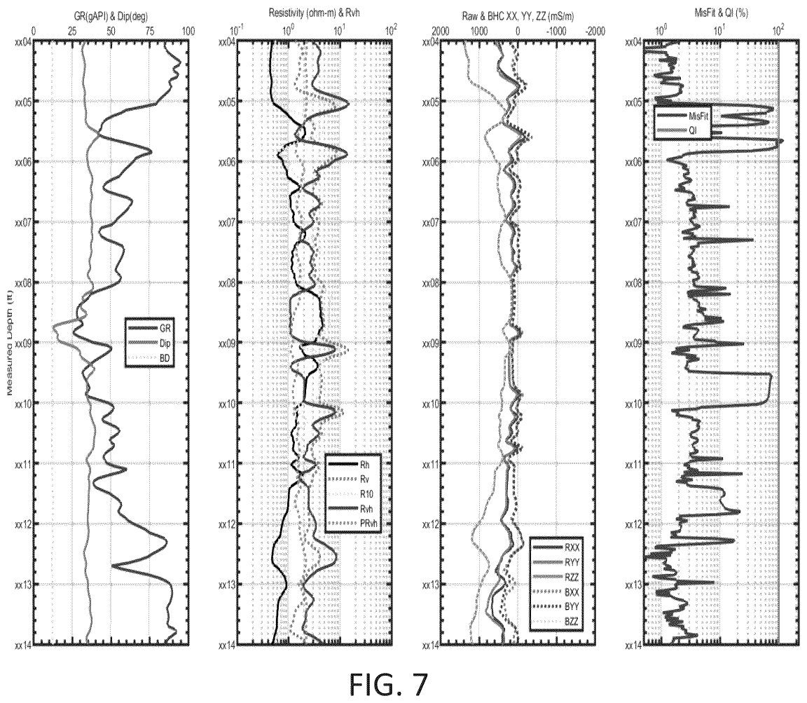

FIG. 7 illustrates inverted The MCI inverted resistivity values and anisotropy ratio values of the inversion without an PRvh enhancement for depth. In a first image (Track 1) from left—GR, inverted dip, bore diameter (BD); In a second image (Track 2)—Rh and Rv: inverted horizontal 7 vertical resistivity, R10: conventional array resistivity with DOI of 10; Rvh: inverted resistivity ratio; PRvh—GR-derived resistivity ratio; In a third image (Track 3)—all solid lines are the raw XX, YY, and ZZ, and all dotted lines are the BHC XX, YY, and ZZ; Track 4—Misfit and QI (quality index).

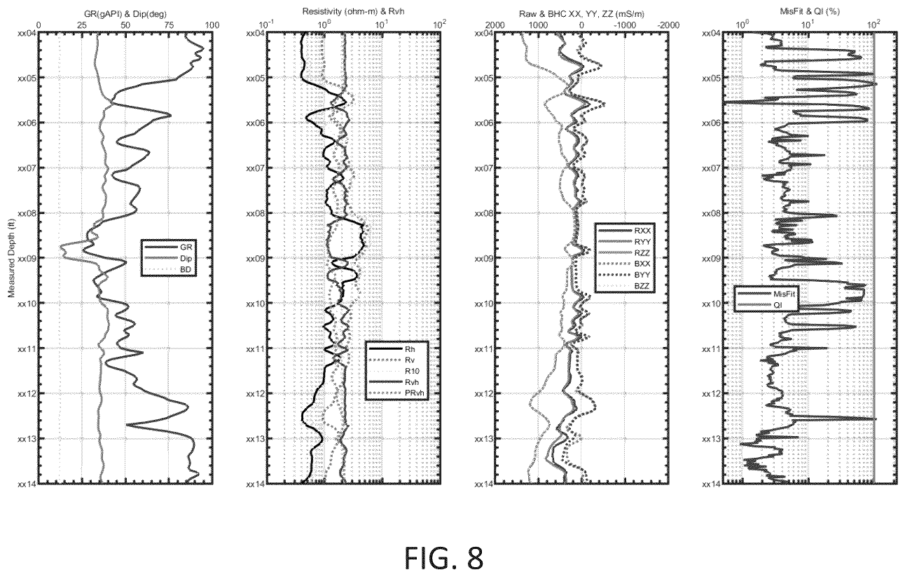

FIG. 8 illustrates a plot of EM log data that has been inverted and shows a plot of GR log data. FIG. 8 illustrates that Rvh values have been overestimated along several sections (e.g., measured depths) of a wellbore. This may be due to strong horn effects of particular EM the XX, YY, and XY, YX receivers. To mitigate this Rvh overestimation, the enhanced MCI inversion discussed in respect to FIG. 4 of raw MCI EM data may be performed. Graphs of the inverted logs are displayed in FIG. 8. After comparing these graphs of FIGS. 5-7, we observe the Rvh overestimate issue in FIG. 7 is significantly reduced in FIG. 8. As such the dual-mode (two-mode) inversion of the present disclosure may increase the accuracy of wellbore evaluations.

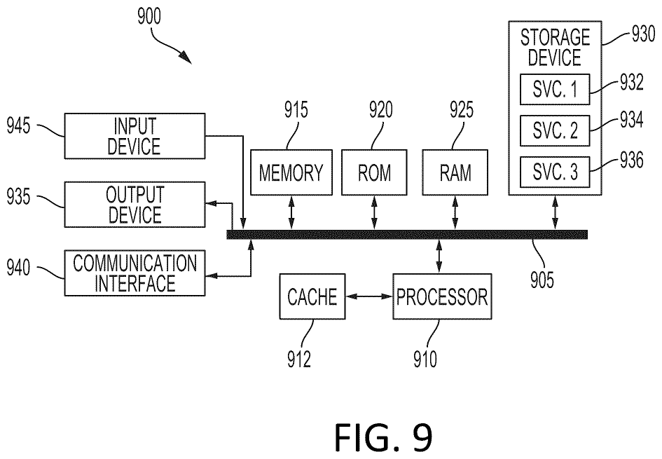

FIG. 9 illustrates an example computing device architecture 900 which can be employed to perform any of the systems and techniques described herein. In some examples, the computing device architecture can be integrated with the electromagnetic imager tools described herein. Further, the computing device can be configured to implement the techniques of controlling borehole image blending through machine learning described herein.

The components of the computing device architecture 900 are shown in electrical communication with each other using a connection 905, such as a bus. The example computing device architecture 900 includes a processing unit (CPU or processor) 910 and a computing device connection 905 that couples various computing device components including the computing device memory 915, such as read only memory (ROM) 920 and random access memory (RAM) 925, to the processor 910.

The computing device architecture 900 can include a cache of high-speed memory connected directly with, in close proximity to, or integrated as part of the processor 910. The computing device architecture 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other computing device memory 915 may be available for use as well. The memory 915 can include multiple different types of memory with different performance characteristics. The processor 910 can include any general purpose processor and a hardware or software service, such as service 1 932, service 2 934, and service 3 936 stored in storage device 930, configured to control the processor 910 as well as a special-purpose processor where software instructions are incorporated into the processor design. The processor 910 may be a self-contained system, containing multiple cores or processors, a bus, memory controller, cache, etc. A multi-core processor may be symmetric or asymmetric.

To enable user interaction with the computing device architecture 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art, such as a display, projector, television, speaker device, etc. In some instances, multimodal computing devices can enable a user to provide multiple types of input to communicate with the computing device architecture 900. The communications interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. The storage device 930 can include services 932, 934, 936 for controlling the processor 910. Other hardware or software modules are contemplated. The storage device 930 can be connected to the computing device connection 905. In one aspect, a hardware module that performs a particular function can include the software component stored in a computer-readable medium in connection with the necessary hardware components, such as the processor 910, connection 905, output device 935, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1: A method for inverting multi-component induction (MCI) data in laminated formations comprises: logging the formation with MCI tool and acquiring MCI data; recording a gamma ray (GR) log of the formation; processing the MCI data through a first inverse model to obtain a first set of parameters pertinent to the formation anisotropy; computing at least one pseudo parameter pertinent to the formation anisotropy based on the GR log and the first set of parameters pertinent to the formation anisotropy; processing the MCI data through a second inverse model to obtain a second set of parameters pertinent to the formation anisotropy, wherein the second inverse model is based in part on the pseudo parameter. Alternatively or additionally, Aspect 1 may include: performing a first set of mathematical operations on a set of formation resistivity data to identify a set of formation values; evaluating a set of gamma ray (GR) formation log data collected to identify a set of formation GR values; performing a second set of mathematical operations on the formation resistivity data based on the set of formation GR values; and updating the set of formation values based on the performance of the second set of mathematical operations.

Aspect 2: The method of Aspect 1, wherein the inverse model comprises iteratively minimizing the difference between acquired MCI data and synthetic response predicted by a forward model.

Aspect 3: The method Aspect 1 or 2, wherein the first set of parameters pertinent to the formation anisotropy comprises formation vertical resistivity Rv or anisotropy ratio Rv/Rh.

Aspect 4: The method of any of Aspects 1 through 4, wherein computing at least one pseudo parameter pertinent to the formation anisotropy comprises computing pseudo Rv or pseudo Rv/Rh as a function of GR log and the first set of parameters pertinent to the formation anisotropy.

Aspect 5: The method of Aspect 4, wherein computing the pseudo Rv or pseudo Rv/Rh comprises identifying a shale section, a sand section, and constructing a mapping function to map GR log to pseudo Rv or pseudo Rv/Rh based on the identified shale and sand section.

Aspect 6: The method of any of Aspects 1 through 5, wherein the GR log is obtained from a wireline or LWD log. Same pass or a different pass. Speed correction and depth alignment is applied to align GR with MCI logs.

Aspect 7: The method of any of Aspects 1 through 6, wherein a resolution matching algorithm is applied to match the vertical resolution of GR and MCI logs.

Aspect 8: The method of any of Aspects 1 through 7, wherein the second processing uses the pseudo Rv or pseudo Rv/Rh parameters as initial guess to the inversion.

Aspect 9: The method of any of Aspects 1 through 8, wherein the second processing uses the pseudo Rv or pseudo Rv/Rh parameters as upper bounds on the inverse model parameters.

Aspect 10: The method of any of Aspects 1 through 9, wherein the second processing uses the pseudo Rv or pseudo Rv/Rh as soft constraints or regularization terms.

Aspect 11: The method of of Aspect 10, wherein the strength of the regularization term is optimized to maximize the quality of the inversion as indicated by at least one indicator.

Aspect 12: The method of any of Aspect 1 through 11, wherein the uranium contribution is subtracted from the GR log to give more accurate measure of shale in carbonates.

Aspect 13: The method of any of Aspect 1 through Aspect 12, wherein neutron logs are used in conjunction with GR logs to estimate the volume of laminated vs. dispersed shale. The volume of laminated shale is mapped to pseudo Rv or pseudo Rv/Rh.

Aspect 14: The method of any of Aspects 1 through 13, wherein borehole image logs are used in conjunction with GR logs to identify at least one zone with predominantly laminated shale. That zone is used to construct the constructing a mapping function to map GR log to pseudo Rv or pseudo Rv/Rh.

Aspect 15: The method any of Aspects 1 through 14, wherein the difference between the pseudo parameter and the second set of parameters pertinent to the formation anisotropy is used as an indicator for the presence of dispersed shale or carbonates (both of which may inflate GR and therefore the pseudo parameter but should have a less significant impact on Rv/Rh from MCI).

Aspect 16: The method of any of Aspects 1 through 15, further comprising: accessing a set of GR log data collected by a GR device; identifying that the GR log data collected by the GR device includes GR uranium data; removing the GR uranium data from the GR log data to generate the GR formation log data; and identifying a measure of shale in carbonates that are included in a wellbore formation based on the GR formation log data not including the GR uranium data.

Aspect 17: The method of any of Aspects 1 through 16, further comprising: estimating a volume of laminated shale versus dispersed shale included in a wellbore formation based on a combination of neutron log data and GR log data; and mapping the volume of laminated shale to a pseudo vertical resistivity (Rv) value or a pseudo anisotropy ratio (Rv/Rh) value that corresponds to the Rv value divided by a pseudo horizontal resistivity (Rh) value.

Aspect 18: The method of any of Aspects 1 through 17, further comprising: evaluating borehole imaging logs and GR logs to identify at least one zone with a laminated shale value that meets a threshold value; and generating a mapping function that maps the formation GR log data to a pseudo vertical resistivity (Rv) value or a pseudo anisotropy ratio (Rv/Rh) value that corresponds to the Rv value divided by a pseudo horizontal resistivity (Rh) value.

Aspect 19: The method of any of Aspects 1 through 18, further comprising: identifying a difference between a pseudo parameter and a second set of parameters pertinent to formation anisotropy; and identifying at least one of a measure of dispersed shale or a measure of carbonates included in a wellbore formation based on the identified difference limiting changes included in the updated set of formation values.

Aspect 20: A system comprising: an electromagnetic (EM) sensing device that collects a set of formation resistivity data; a gamma ray (GR) sensing device that senses GR data, wherein at least a portion of the sensed GR data is included in a set of GR formation log data; a memory; one or more processors that execute instructions out of the memory to: perform a first set of mathematical operations on the set of formation resistivity data to identify a set of formation values; evaluate the set of gamma ray (GR) formation log data collected to identify a set of formation GR values; perform a second set of mathematical operations on the set of formation resistivity data based on the set of formation GR values; and update the set of formation values based on the performance of the second set of mathematical operations.

Aspect 21: A non-transitory computer-readable storage medium having embodied thereon instructions executable by one or more processors to perform a method comprising: performing a first set of mathematical operations on a set of formation resistivity data to identify a set of formation values; evaluating a set of gamma ray (GR) formation log data collected to identify a set of formation GR values; performing a second set of mathematical operations on the formation resistivity data based on the set of formation GR values; and updating the set of formation values based on the performance of the second set of mathematical operations.

What is claimed is:

1. A method comprising:
performing a first set of mathematical operations on a set of formation resistivity data to identify a set of formation values;
evaluating a set of gamma ray (GR) formation log data collected to identify a set of formation GR values;
performing a second set of mathematical operations on the formation resistivity data based on the set of formation GR values; and
updating the set of formation values based on the performance of the second set of mathematical operations.

2. The method of claim 1, wherein:
the set of formation values include resistivity values that include one or more of a vertical resistivity value (Rv), a horizontal resistivity value (Rh), and a formation resistivity anisotropy value (Rvh), and
the first set of mathematical operations includes a first computer modeling inversion calculation based on the set of resistivity data being collected by a multi-component induction (MCI) tool deployed in a wellbore.

3. The method of claim 1, further comprising:
aligning data points included in the set of formation resistivity data with data points included in the set of formation GR log data based on a span of wellbore locations where the set formation resistivity data and the set of formation GR log data was collected.

4. The method of claim 1, further comprising:
identifying a first speed associated with the set of formation resistivity data;
identifying a second speed associated with the set of GR formation log data; and
aligning data points included in the set of formation resistivity data with data points included in the set of formation GR log data based on the first speed and the second speed.

5. The method of claim 1, further comprising:
identifying one or more upper boundaries based on the set of formation GR values, wherein the one or more upper boundaries limit parameters of a computer inversion model that includes instructions of the second set of mathematical operations.

6. The method of claim 1, further comprising:
generating a formation mapping that includes a shale section and a sand section, wherein the set of formation values are updated based on the formation mapping including the shale section and the sand section, wherein the mapping maps the set of formation GR values to one or more pseudo parameters.

7. The method of claim 1, wherein the set of formation values include a vertical resistivity (Rv) value and an anisotropy ratio (Rv/Rh) value that corresponds to the Rv value divided by a horizontal resistivity (Rh) value.

8. The method of claim 1, wherein the first set of mathematical operations are implemented by instructions of an inversion model and execution of the instructions of the inversion model iteratively minimize a difference between the formation resistivity data and a synthetic response predicted by a forward model.

9. The method of claim 1, wherein the GR values include one or more pseudo parameters pertinent to formation anisotropy, and the one or more pseudo parameters include a pseudo vertical resistivity (Rv) value or a pseudo anisotropy ratio (Rv/Rh) value that corresponds to the Rv value divided by a pseudo horizontal resistivity (Rh) value.

10. The method of claim 9, wherein the pseudo Rv value or the pseudo Rv/Rh value are at least one of a soft constraint or regularization term.

11. The method of claim 10, wherein a strength of the regularization term is adjusted to increase a quality of an inversion as indicated by at least one indicator.

12. The method of claim 9, further comprising:
estimating an initial pseudo vertical resistivity (Rv) value or an initial pseudo anisotropy ratio value that corresponds to the Rv value divided by a pseudo horizontal resistivity (Rh) value, wherein a second processing accesses an initial pseudo Rv value or the initial pseudo Rv/Rh value as part of the second mathematical operation.

13. The method of claim 9, wherein computing the pseudo Rv value or the pseudo Rv/Rh value includes identifying a shale section, a sand section, and constructing a mapping function to map GR log to a pseudo vertical resistivity (Rv) value or a pseudo anisotropy ratio (Rv/Rh) value that corresponds to the Rv value divided by a pseudo horizontal resistivity (Rh) value.

14. The method of claim 1, wherein the set of formation GR log data is obtained from a wireline or logging while drilling (LWD) log during one or more sensing passes, and wherein a speed correction and a depth alignment are applied to align GR formation log data with the formation resistivity data based on the formation resistivity data being associated with a multi-component induction (MCI) tool.

15. The method of claim 1, wherein a resolution matching algorithm is applied to match a vertical resolution of the set of GR formation log data and the set of formation resistivity data.

16. The method of claim 1, further comprising:
accessing a set of GR log data collected by a GR device;
identifying that the GR log data collected by the GR device includes GR uranium data;
removing the GR uranium data from the GR log data to generate the GR formation log data; and
identifying a measure of shale in carbonates that are included in a wellbore formation based on the GR formation log data not including the GR uranium data.

17. The method of claim 1, further comprising:
estimating a volume of laminated shale versus dispersed shale included in a wellbore formation based on a combination of neutron log data and GR log data; and
mapping the volume of laminated shale to a pseudo vertical resistivity (Rv) value or a pseudo anisotropy ratio (Rv/Rh) value that corresponds to the Rv value divided by a pseudo horizontal resistivity (Rh) value.

18. The method of claim 1, further comprising:
evaluating borehole imaging logs and GR logs to identify at least one zone with a laminated shale value that meets a threshold value; and
generating a mapping function that maps the formation GR log data to a pseudo vertical resistivity (Rv) value or a pseudo anisotropy ratio (Rv/Rh) value that corresponds to the Rv value divided by a pseudo horizontal resistivity (Rh) value.

19. The method of claim 1, further comprising:
identifying a difference between a pseudo parameter and a second set of parameters pertinent to formation anisotropy; and
identifying at least one of a measure of dispersed shale or a measure of carbonates included in a wellbore formation based on the identified difference limiting changes included in the updated set of formation values.

20. A system comprising:
an electromagnetic (EM) sensing device that collects a set of formation resistivity data;
a gamma ray (GR) sensing device that senses GR data, wherein at least a portion of the sensed GR data is included in a set of GR formation log data;
a memory;
one or more processors that execute instructions out of the memory to:
perform a first set of mathematical operations on the set of formation resistivity data to identify a set of formation values;
evaluate the set of gamma ray (GR) formation log data collected to identify a set of formation GR values;
perform a second set of mathematical operations on the set of formation resistivity data based on the set of formation GR values; and
update the set of formation values based on the performance of the second set of mathematical operations.

21. A non-transitory computer-readable storage medium having embodied thereon instructions executable by one or more processors to perform a method comprising:
performing a first set of mathematical operations on a set of formation resistivity data to identify a set of formation values;
evaluating a set of gamma ray (GR) formation log data collected to identify a set of formation GR values;
performing a second set of mathematical operations on the formation resistivity data based on the set of formation GR values; and
updating the set of formation values based on the performance of the second set of mathematical operations.
